(19) United States
(12) Patent Application Publication
(10) Pub. No.: US 2016/0069735 A1
(43) Pub. Date: Mar. 10, 2016

(54) INSTANT WEIGHT MODE FOR INFANT CARE DEVICE WITH IN-BED SCALE

(71) Applicant: General Electric Company, Schenectady, NY (US)

(72) Inventor: Thomas Charles Underwood, Sykesville, MD (US)

(73) Assignee: GENERAL ELECTRIC COMPANY, Schenectady, NY (US)

(21) Appl. No.: 14/482,310

(22) Filed: Sep. 10, 2014

(51) Int. Cl. G01G 19/44

(52) U.S. Cl. CPC G01G 19/445

(57) ABSTRACT

A method and system for determining the weight of an infant when the infant is initially placed upon a support platform of an infant care device. Prior to placing an infant on the support platform, a control unit of the infant care device enters into an instant weight mode. In the instant weight mode, the control unit obtains one or more initial weight readings from one or more sensors positioned beneath the support platform to zero out the weight reading. When an infant is placed upon the support platform, the control unit calculates and displays the weight of the infant. A caregiver manually accepts the displayed weight as the initial weight of the infant and the control unit exits the instant weight mode.

### BACKGROUND OF THE INVENTION

The present disclosure generally relates to a method and apparatus for accurately weighing a patient, such as an infant. More specifically, the present disclosure relates to a method and apparatus that determines the weight of an infant when the infant is initially placed on a scale and displays the weight for viewing and acceptance by a caregiver.

Traditionally, methods of weighing infants require removal of the infant from one environment, such as an incubator, placing the infant on a scale for weighing, and returning the infant to the prior environment. The typical sequence of events when using such scales is that the scale is first activated (usually by the pressing of a key) and scale is then tared to zero. Such a scale requires the infant to be lifted from the bed to initiate the weighing process. Once the patient has been lifted, the scale is tared to a zero reading, which takes into account all of the items currently on the bed. Once the scale has been zeroed, the patient is placed on the bed and the weight of the patient is displayed. It can be appreciated that this sequence of events requires removing the infant from the incubator, which disturbs the infant and requires time to zero out the scale. Another common type of available scale allows the weight of the infant to be determined when the infant is on the bed without having to disturb the patient. However, in such a system, all extraneous items, such as pacifiers, beanie infants, pillows, blankets, etc. must be removed from the bed. Further, the caregiver must try to manually negate the effect of any intravenous lines and tubing that are attached to the infant in order to provide an accurate weight.

In many cases, the scale is designed to have a pre-defined period during which the infant can be weighted. If the caregiver cannot place the infant on the scale during this time, the scale times out and the process must begin again. Since caregivers are often very busy in the birthing room and the time of delivery is difficult to judge, caregivers often initiate the weight process only after the infant has been born.

In each of the two techniques described above, the caregiver must spend time to tare the scale and initiating the weighing process. Both of these two steps increase the amount of time needed for a caregiver to record an initial weight of the infant. It has been recognized that it would be desirable to have a technique for accurately weighing an infant when the infant is initially placed onto the scale. It is desirable for such a system and method to be ready to receive the infant and continuously display a measured weight, which can be accepted and authorized by the caregiver.

### SUMMARY OF THE INVENTION

The present disclosure generally relates to a system and method for accurately weighing a patient, such as an infant. The system and method of the present disclosure includes an instant weight mode that calculates the weight of the infant when the infant is initially placed on a bed with an in-bed scale such that the weight of the infant is determined and displayed continuously.

The system of the present disclosure includes a support platform and sensor that support a mattress within an infant care device. The sensor generates a weight reading based upon the amount of weight on the support platform. The amount of weight on the support platform can include the mattress and various different sensors and components associated with the infant when the infant is on the bed.

The infant care device of the present disclosure includes a control unit that can operate in an instant weight mode. In the instant weight mode, the control unit initially obtains weight readings from a sensor positioned beneath the support platform. Based upon the initial readings from the sensor, the control unit sets a baseline weight which represents the weight of objects and components, as well as a mattress, on the support platform before the infant is placed on the support platform. The initial weight is set as a baseline weight in the control unit, and a zero value is displayed to a caregiver. The zero value displayed to the caregiver indicates that the infant care device is ready to receive and weigh an infant. The infant care device remains ready to receive the infant for an indefinite period of time and the instant weight mode does not time out.

The control unit obtains current weight readings from the sensor positioned beneath the support platform at regular intervals. Based upon the current weight readings, the control unit determines whether an infant is positioned on the support platform. If an infant is not located on the support platform, the control unit displays a zero weight.

If an infant is positioned on the support platform, the control unit calculates a measured weight of the infant as the difference between the baseline weight and the most recent weight reading. The measured weight of the infant is continuously displayed for viewing by the caregiver.

If the displayed weight of the patient appears correct, the caregiver can enter a user input to indicate that the measured weight is acceptable. The measured weight is then entered into a memory location within the control unit and is used as the initial weight of the infant for subsequent processing and calculations.

The infant care device enters the instant weight mode upon initial start up or upon receiving a user input. It is desirable that the infant care device enter the instant weight mode upon the initial activation of the infant care device such that the infant care device is ready to receive an infant. By entering the instant weight mode, the infant care device will be ready to receive an infant whenever the caregiver desires. The infant care device displays a zero reading prior to receiving an infant, which indicates that the infant care device is ready to receive the infant.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a detailed view of the infant care device including various monitoring components for an infant;

FIG. 2 is a schematic illustration of the weighing system operating in accordance with the present disclosure; and

FIG. 3 is a flow chart illustrating the operating sequence carried out by the control unit of the infant care device.

### DETAILED DESCRIPTION OF THE INVENTION

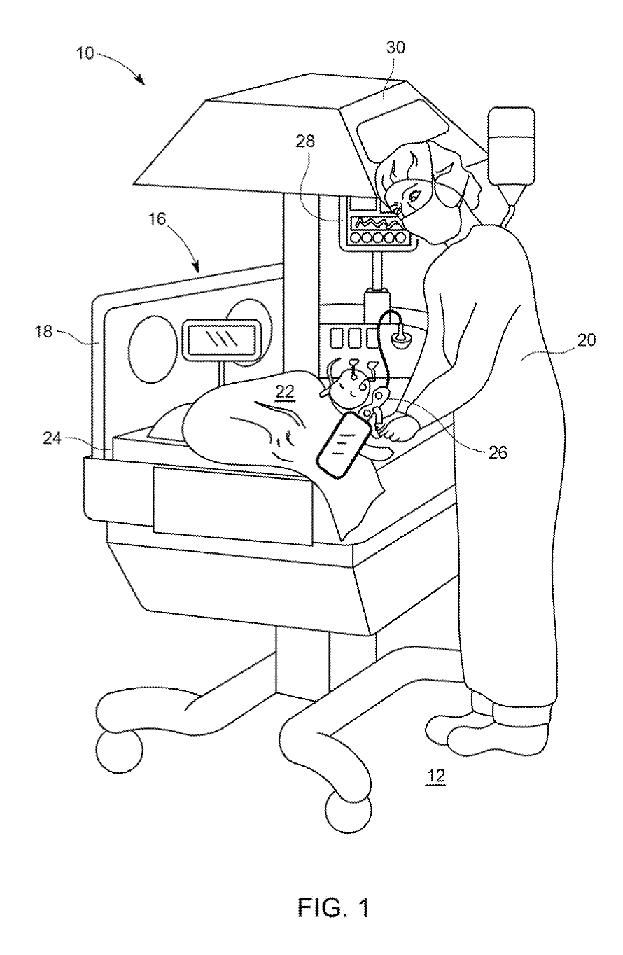

FIG. 1 illustrates one embodiment of an infant care device 10 that incorporates the method of weighing an infant in accordance with the present disclosure. In the embodiment shown in FIG. 1, the infant care device 10 is located within a patient's room 12, which may be part of a labor and delivery room or environment. The infant care apparatus 10 shown in FIG. 1 could be many different types of devices, such as an incubator-type infant care apparatus or a patient wanner. The incubator-type device 10 shown in FIG. 1 defines a microenvironment region 16 in which the patient rests and receives therapy, including heating and possible oxygen enrichment.

The sides 18 of the infant care device 10 can be lowered such that a caregiver 20 can have access to an infant 22 positioned on a mattress 24. Various different patient sensors 26 can be attached to the infant such that the infant, care device 10 can monitor physiological parameters from the infant. The monitored physiological parameters are shown on a display 28 and can be viewed by the caregiver 20. As illustrated in FIG. 1, a relatively significant number of devices may be positioned on the mattress 24 along with the infant 22. These components can include intravenous tubes, pillows, blankets, patient sensors, and other similar components. In the embodiment shown in FIG. 1, a radiant heating hood 30 is positioned above the infant 22 and heats the infant as desired. As described previously, it is desirable that the infant 22 remain within the microenvironment created by infant care device 10 such that the patient remains warm and is disturbed as infrequently as possible.

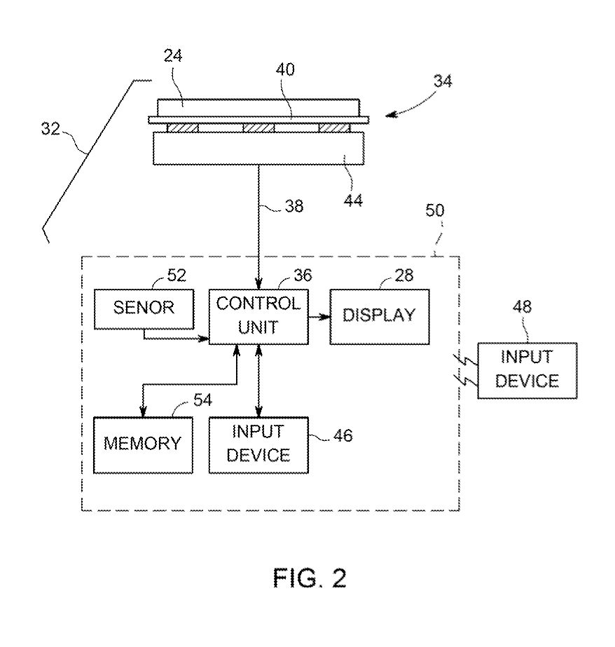

Although not shown in FIG. 1, the infant care device 10 includes a weighing system that determines the weight of the infant 22 and displays the weight on the display 28. The weighing system of the present disclosure is positioned beneath the mattress 24 and is schematically shown in FIG. 2 by reference numeral 32. The weighing system 32 includes a scale 34 and a control unit 36, which is preferably a microprocessor capable of running a processing routine. The control unit 36 could be a separate processor from the control unit of the infant care device or could be incorporated into the processor of the infant care device. The scale 34 is any conventional weighing device that is capable of outputting a signal along line 38 that is indicative of the weight of the objects placed thereon. Preferably, the scale 34 is an in-bed scale having a support platform 40 that supports the mattress 24 that is configured to fit inside the infant care device 10, either as a component of the originally manufactured equipment, as a retrofit item to an existing infant bed, or as a stand-alone unit. A sensor 44 associated with the support platform 40 outputs a signal along line 38 that is indicative of the weight supported by the platform 40, which includes the mattress 24, and any items positioned on the mattress, including an infant. In one embodiment of the disclosure, the sensor 44 in the scale 34 is configured as either a single or a multiple point load cell design that is accurate to +/−10 grams. Although the term sensor is used in the disclosure, this term should be interpreted broadly to cover any device or devices that generate a numeric representation of weight or pressure.

The weighing system 32 also includes an input device 46 that communicates with the control unit 36 for providing information to the controller, as discussed in detail below. In addition to the input device 46, a wireless input/output device 4$ can be used and remotely located from the control unit 36. The wireless input/output device 48 communicates through wireless communication techniques such that the caregiver can enter information into the control unit 36 from a location remote to the housing 50 including the control unit 36 and the input device 46. As illustrated in FIG. 2, the display 28 is associated with the control unit 36 such that information from the control unit 36 can be displayed and monitored by the caregiver in the location near the infant care device. Additionally, it is contemplated that the control unit 36 could communicate with a remote location, such as a monitor at a nurses' station in the hospital or any other remote location. The data provided to the remote location from the control unit 36 can be displayed in real-time, stored in a database, processed further, or any combination thereof. In this manner, a database of weight collected for the infant associated with the infant care device 10 can be analyzed and monitored from a remote location.

The present disclosure also contemplates that the weighing system 32 could include one or more additional sensing devices 52 that allow the weighing system to come to a more accurate weight determination. As an example, the sensing device 52 could be a temperature sensor, a humidity sensor, a pressure sensor or any combination thereof to provide additional inputs to the control unit 36 such that the control unit can more accurately determine the weight of a patient. The present disclosure also contemplates that the scale includes a support platform 40 that could be tilted in either direction. In such an embodiment, the system 32 would include an inclinometer or accelerometer to measure the angle of the bed.

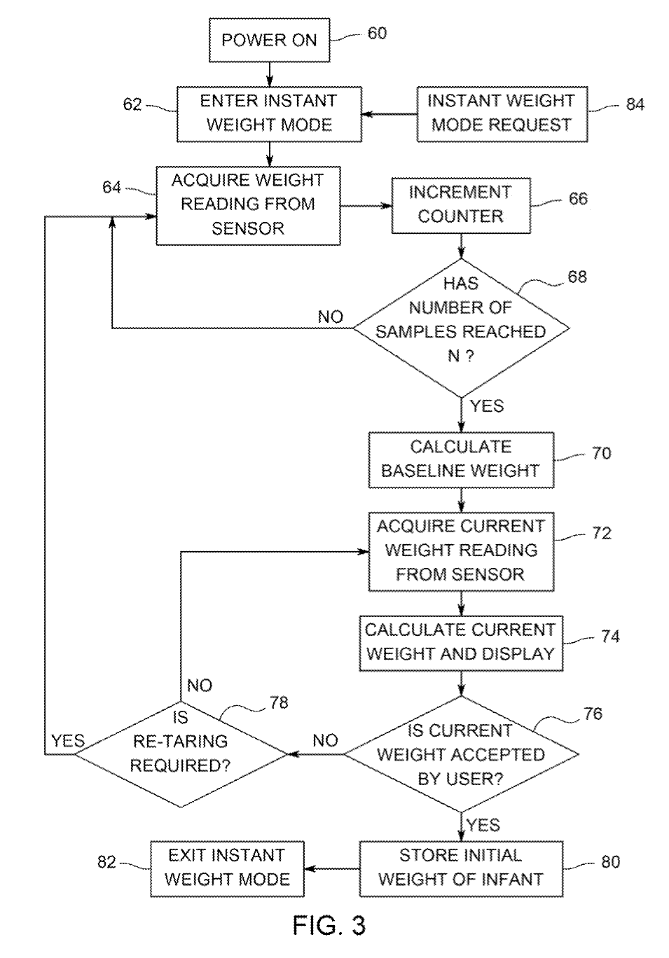

FIG. 3 illustrates one possible operating sequence carried out by the control unit 36 of the weighing system 32. Although the operational sequence set forth in FIG. 3 provides one exemplary embodiment of the disclosure, it should be understood that the operational sequence could be varied while operating within the scope of the present disclosure.

As illustrated in FIG. 3, when the infant care device is initially turned on, the control unit of the infant care device begins a series of standard procedures and steps that prepare the infant care device for receiving an infant. Although not shown and described in the present disclosure, one of the procedures initiated by the control unit upon start up is a warming procedure to raise the temperature of the environment contained within the infant care device to a preset, initial value. This preset, initial value allows the infant care device to be warm when the infant is initially placed within the micro environment region. When the control unit senses the presence of an infant, the control unit then controls the temperature within this environment to hold the environment at a user selected temperature.

In addition to initiating the heating procedures described above, the control unit can he programmed to enter into an instant weight mode upon startup, as indicated by step 62. When the control unit enters into the instant weight mode in step 62, the infant care device is configured to accept an infant patient and to generate an instant weight of the patient for viewing and acceptance by the caregiver. In currently available infant care devices, the caregiver must actively initiate a weighing procedure, usually by pressing a key or button, which requires the scale within the infant care device to be tared. This procedure often requires the removal of the infant from the bed to initiate the weighing process and the procedure has a predefined period that can time out if the infant is not presented for weighing. In accordance with the system and method of the present disclosure, the control unit of the infant care device automatically enters into the instant weight mode in step 62 after start up and remains in this mode indefinitely such that the infant care device is ready to receive an infant and immediately weigh the infant.

In step 64, the control unit acquires a weight reading from the weight sensor or sensors 44 positioned beneath the support platform. The initial weight reading taken in step 64 will include the weight of the mattress 24 and any devices or other components positioned on the support platform. These components can include intravenous tubes, pillows, blankets, patient sensors and other similar components.

Once the control unit acquires the weight reading from the sensor, the control unit proceeds to step 66 in which a counter is incremented. Once the counter is incremented, the control unit proceeds to step 68 in which the control unit determines whether a minimum number of readings have been recorded. It is contemplated that the control unit can have a sample rate of one sample per second, or higher. In the embodiments shown in FIG. 3, the acceptable number of readings in step 68 is set at five, although other values for the number of readings N can vary. If the system has not obtained the required number of readings in step 68, the control unit returns to step 64 and again requires a weight reading from the sensor. This process repeats until the desired number of readings N has been reached in step 68.

Once the required number of readings has been obtained in step 68, the control unit proceeds to step 70 in which the control unit calculates a baseline weight. The baseline weight calculated in step 60 is based upon the signal received from the sensor position beneath the support platform before an infant is placed upon the support platform. Thus, the baseline weight calculated in step 70 will include both the mattress and other components positioned on the support platform but will not include the weight of the infant.

The baseline weight calculated in step 70 can be an average of the multiple readings or could be calculated in different was based upon the number of readings obtained, such as by disregarding the largest and smallest readings before calculating the average.

Once the baseline weight has been calculated, the baseline weight is stored within the control unit. The baseline weight represents the weight of the components and the mattress on the support platform before receipt of the infant.

The control unit then proceeds to step 72 in which the control unit acquires a current weight reading from the sensor positioned beneath the support platform. If the infant has not yet been placed on the platform, the current weight reading obtained in step 72 should be approximately equal to the baseline weight calculated in step 70. If an infant has been placed on the platform, the current weight calculated in step 74 will represent the weight of the infant.

If an infant has not yet been placed on the support platform, the control unit will display a zero reading as the current weight. The zero reading will be displayed for the caregiver to view. When a zero weight is displayed, the caregiver will be able to determine that the infant care device is ready to receive a patient and that the infant care device is operating properly in the instant weight mode.

It is contemplated that the control unit will display a zero reading when the current weight is within a selected percentage of the baseline weight to compensate for noise and slight variations in the static weight of the components on the support platform. As described above, the zero reading on the display of the infant care device will alert the caregiver that the infant care device is operating within the instant weight mode and is ready to receive an infant patient. The infant care device will remain in this mode indefinitely while waiting to receive the infant for weighing.

The control unit and sensor are programmed to obtain a weight reading from the sensor on a periodic, regular interval. As an example, the control unit can obtain a weight reading from the sensor multiple times per second or once per second, although other sampling rates are contemplated. If an infant is placed on the support platform, the current weight calculated in step 74 will represent the actual weight of the infant. Since the infant will move when positioned on the support platform, the current weight displayed in step 74 may vary slightly. However, since the current weight is displayed in real time, the caregiver will be able to quickly view and assess the measured weight of the infant. In this manner, the infant care device generates an nearly instant measurement of the infant weight and continuously displays the most recent calculation when the infant is first placed on the support platform of the infant care device.

The control unit proceeds to step 76 which the control unit determines whether the caregiver has accepted the current weight as the infant weight. Since the instant weight mode is primarily desirable for use upon the initial placement of the infant within the infant care device, the caregiver is prompted to accept the displayed weight as the infant weight. If the caregiver does not select the current, displayed weight as the infant weight, the method proceeds to step 78 in which the control unit determines whether the caregiver is requesting that the baseline weight be re-determined. If the caregiver is not requesting that the scale be tared again, the method proceeds back to step 72 in which the control unit acquires another current weight reading from the sensor. The weight readings from the sensor are obtained on a regular basis, such as once per second. The system continues to proceed through steps 72-76 until the caregiver accepts the current weight as the infant weight. Once the caregiver accepts the current weight as the infant weight, the control unit proceeds to step 80 in which the initial weight of the infant is stored in a memory location. The stored, initial weight of the infant is used for a variety of monitoring procedures, many of which are based upon the initial weight of the infant when the infant was placed within the infant care device. Once the initial weight of the infant has been stored in step 80, the system proceeds to step 82 in which the infant care device exits the instant weight mode and begins operating in a normal manner.

If the caregiver requests that the scale be tared in step 78, the control unit proceeds back to step 64 in which the control unit acquires multiple weight readings from the sensor and calculates a baseline weight in step 70. The request to tare the scale from step 78 may be required when the caregiver places additional components on the support platform, which results in a current weight which varies from the baseline weight value. Likewise, if components are removed from the support platform, the scale may need to be tared, as requested in step 78 by the caregiver or, since the current weight will be negative, can be automatically initiated by the control unit.

As described previously, the infant care device enters the instant weight mode upon initial power up of the infant care device. In addition, the control unit can enter the instant weight mode upon receiving a caregiver request, as indicated by step 84. The request from the caregiver may be initiated by a touch screen, a dedicated input device or any other component that allows the caregiver to indicate to the control unit that the control unit should enter the instant weight mode. Once the control unit enters the instant weight mode in step 62, the control unit proceeds as described.

As can be understood by the method steps shown in FIG. 3, the infant care device, upon entry into the instant weight mode, generates a baseline weight measurement which will be zeroed out prior to placement of the infant on the support platform. The control unit continuously displays the zero reading, which indicates to the caregiver that the infant care device is ready to receive a patient.

Once the patient is placed upon the support platform, current weight is calculated and displayed for acceptance by the caregiver. Once the caregiver accepts the current weight, which is displayed, the infant weight is stored and used for subsequent processing steps. Once the initial weight of the patient has been determined, the infant care device exits the instant weight mode and begins operating as normal.

As can be understood by the above flowcharts, the system will generate a calculated weight and display the weight to the caregiver for validation upon placement of an infant on a mattress. This event will result in the weight varying from the baseline weight. Thus, when the infant is placed on the mattress, the system will present the caregiver with a calculated infant weight measurement. The caregiver can then either validate this measurement or discard the measurement as desired. It is contemplated that the automated process described in FIG. 3 could be turned off from the infant care device if the infant is being placed on and removed front the mattress on regular intervals. However, the system and method described allows the weight of the infant to be calculated when the infant is placed on the mattress for the first time.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A method of determining the weight of an infant the method comprising the steps of:
initiating an instant weight mode in a control unit of an infant care device;
obtaining an initial weight reading from a sensor positioned to detect the weight of a support platform and objects positioned on the support platform, wherein the initial weight reading is taken prior to placement of the infant on the support platform;
setting a baseline weight in the control unit based upon the initial weight reading;
obtaining current weight readings from the sensor;
displaying a zero weight when the current weight reading is equal to the baseline weight;
generating a measured weight of the infant as the difference between the baseline weight and the recent weight reading; and
continuously displaying the measured weight.

2. The method of claim 1 further comprising the steps of:
receiving a user input in the control unit indicating an acceptance of the measured weight; and
storing the accepted, measured weight in the control unit as an infant weight.

3. The method of claim 1 wherein the instant weight procedure is initiated by a user.

4. The method of claim 1 wherein the instant weight procedure is initiated upon activation of the infant care device.

5. The method of claim 2 wherein the control unit exits the instant weight mode upon acceptance of the measured weight.

6. The method of claim 1 wherein the baseline weight is set based upon a plurality of initial weight readings.

7. The method of claim 1 wherein the zero weight is displayed when the current reading is within a pre-determined range of the baseline weight.

8. A method of determining the weight of an infant positioned within an infant care device having a support platform the method comprising the steps of:
initiating an instant weight mode in a control unit;
setting a baseline weight in the control unit based upon the detected weight of the support platform and objects positioned on the support platform prior to placement of the infant on the support platform;
obtaining, weight readings from a sensor associated with the support platform;
displaying a zero weight when the current weight reading is equal to the baseline weight; and
continuously displaying a measured weight of the infant upon placement of the infant on the support platform.

9. The method of claim 8 further comprising the steps of:
receiving a user input in the control unit indicating an acceptance of the measured weight; and
setting the accepted, measured weight in the control unit as an infant weight.

10. The method of claim 8 wherein the instant weight procedure is initiated by a user.

11. The method of claim 8 wherein the instant weight mode is initiated upon activation of the infant care device.

12. The method of claim 9 wherein the control unit exits the instant weight mode upon acceptance of the measured weight.

13. The method of claim 8 wherein the zero weight is displayed when the current reading is within a pre-determined range of the baseline weight.

14. A system for determining the weight of an infant, comprising:
a support platform sized to receive and support the infant;
a sensor position to detect the weight of the support platform and objects positioned on the support platform; and
a control unit in communication with the sensor to receive a weight signal from the sensor, wherein the control unit is programmed to enter an instant weight mode including:
defining a baseline weight in the control unit, wherein the baseline weight is the weight of the support platform and objects positioned on the support platform prior to placement of the infant on the support platform;
obtaining a current weight reading from the sensor;
displaying a zero weight when the current weight sample is equal to the baseline weight;
generating a measured weight of the infant as the difference between the baseline weight and the most recent weight sample; and
continuously displaying the measured weight.

15. The system of claim 14 wherein the instant weight mode is initiated through an input device.

16. The system of claim 14 wherein the control unit is further programmed to terminate the instant weight mode upon acceptance of the measured weight.

17. The system of claim 14 wherein the instant weight mode is initiated upon activation of the infant care device.

18. The system of claim 14 further comprising a user input device in communication with the control unit, wherein the user initiates the instant weight mode through the user input device.
